(19) United States
(12) Patent Application Publication
(10) Pub. No.: US 2017/0046147 A1
(43) Pub. Date: Feb. 16, 2017

(54) SYSTEMS AND METHODS FOR ASSISTED DRIVER, FIRMWARE AND SOFTWARE DOWNLOAD AND INSTALLATION

(71) Applicant: FUJI XEROX CO., LTD., Tokyo (JP)

(72) Inventor: Russell Shane Neville, Portland, OR (US)

(21) Appl. No.: 14/824,030

(22) Filed: Aug. 11, 2015

(51) Int. Cl. G06F 9/445; H04L 29/08

(52) U.S. Cl. CPC G06F 8/65; H04L 67/10; H04L 67/34; G06F 8/61

(57) ABSTRACT

Described is a network appliance that is able to proactively detect a user's operating system for a particular network enabled device and present the correct driver, firmware or other appropriate software to install on an end user's computing device with a minimum of steps. For example, in one embodiment, the described system creates such an easy installer workflow for end users that they are not aware they are installing “drivers” but instead, installing their “printer”. The network appliance device queries a cloud-based software repository for appropriate driver, firmware or software based on the user's operating system and the information on the network enabled device. Once located, a link to the driver, firmware or software is sent back to the network appliance, which shows it to the user for download and installation by clicking the displayed link.

### BACKGROUND OF THE INVENTION

Technical Field

The disclosed embodiments relate in general to software installation and deployment systems and methods and, more specifically, to systems and methods for assisted driver, firmware and software download and installation.

Description of the Related Art

Unlike many other information technology industries, the printing industry manufacturers have not standardized on way in which to interact with their devices in the important areas of print and scan. As a result, each manufacture creates its own proprietary drivers to take advantage of all the unique features and functions of its devices. These drivers are created typically for the Windows and Mac operating systems and sometimes for Linux as well. Because these drivers are not standard across manufacturers, end users are required to find and install the correct driver that matches the printing product they have purchased. This can be a complex process of searching through manufactures' support websites or trying to locate the correct CD that shipped with the printer. There is usually a multi-step process in which the user must select the correct operating system version to match with the driver file, choose the desired driver (users are faced with PCL, XPS, Postscript), download to their local system and then walk through the installation process. At each step, there is the possibility that the user will select an undesired or incompatible file. This complexity in selecting a driver leads to a high degree of end user frustration and a large number of customer support calls for enabling a user to print from their client computing system.

A similar problem exists for application of device firmware but in this case it is an administrator of the printer devices who is the target end user. Often administrators are not aware that there is new firmware to be applied for their network connected print devices. This new firmware may fix defects, enable new functionality, or address security threats. Even if an administrator proactively looks for firmware, finding the right version for the printer on a manufacturer's website can be a complex process.

As would be appreciated by persons of skill in the art, in view of the aforesaid shortcomings of the conventional technology, it would be advantageous to have new and improved systems and methods that would assist the user in locating, downloading and installing the required driver, firmware and software components.

### SUMMARY OF THE INVENTION

The embodiments described herein are directed to methods and systems that substantially obviate one or more of the above and other problems associated with conventional systems and methods for driver, firmware and software download and installation.

In accordance with one aspect of the inventive concepts described herein, there is provided a computerized system for assisted software download, the system incorporating: a network-connected device disposed on a local area network; a cloud-based software repository; and an appliance device disposed on the local area network and communicatively coupled to the network-connected device, the appliance device incorporating a processing unit and a memory and configured to: discover the network-connected device and determine characteristics of the discovered network-connected device; determine characteristics of a client system accessible by a user; and transmit the characteristics of the discovered network-connected device and the characteristics of the client system accessible by the user to the cloud-based software repository. The cloud-based software repository is configured to receive the characteristics of the discovered network-connected device and the characteristics of the client system accessible by the user from the appliance device, to locate a suitable software based on the received two characteristics and to enable downloading of the located suitable software to the client system accessible by a user.

In one or more embodiments, the network-connected device is a network-connected printer.

In one or more embodiments, enabling downloading of the located suitable software to the client system accessible by a user involves transmitting a link pointing to a file for the software from the cloud-based software repository to the appliance device.

In one or more embodiments, enabling downloading of the located suitable software to the client system accessible by a user involves displaying a link pointing to a file for the software located in the cloud-based software repository on the client system accessible by a user.

In one or more embodiments, the appliance device further incorporates a web server configured to generate a web-based user interface comprising the link pointing to a file for the software located in the cloud-based software repository.

In one or more embodiments, the web-based user interface includes a list of the discovered network-connected devices.

In one or more embodiments, the link pointing to a file for the software located in the cloud-based software repository is displayed upon selection of by a user of a corresponding network-connected device from the list of the discovered network-connected devices.

In one or more embodiments, enabling downloading of the located suitable software to the client system accessible by a user involves downloading a file for the software from the cloud-based software repository to the appliance device, storing the software file on the appliance device and displaying a link pointing to the software file stored on the appliance device on the client system accessible by a user.

In one or more embodiments, the software is a driver for the network-connected device.

In one or more embodiments, the characteristics of a client system include operating system name and version.

In one or more embodiments, the characteristics of the discovered network-connected device include the type of the network-connected device.

In one or more embodiments, the cloud-based software repository includes a catalog of network-connected devices and the corresponding software drivers for supported network-connected device model types.

In accordance with another aspect of the inventive concepts described herein, there is provided a computerized system for assisted firmware download, the system incorporating: a network-connected device disposed on a local area network; a cloud-based software repository; and an appliance device disposed on the local area network and communicatively coupled to the network-connected device, the appliance device incorporating a processing unit and a memory and configured to: discover the network-connected device and determine characteristics of the discovered network-connected device; and transmit the characteristics of the discovered network-connected device to the cloud-based software repository. The cloud-based software repository is configured to receive the characteristics of the discovered network-connected device to locate a suitable firmware based on the received characteristics and to enable downloading of the located suitable firmware for updating firmware of the network-connected device.

In one or more embodiments, the network-connected device is a network-connected printer.

In one or more embodiments, enabling downloading of the located suitable firmware involves transmitting a link pointing to a file for the firmware from the cloud-based software repository to the appliance device.

In one or more embodiments, the appliance device is further configured to automatically download the firmware file from the cloud-based software repository using the link and to apply the downloaded firmware file to the network-connected device.

In one or more embodiments, the appliance device is further configured to prompt a user to download the firmware file from the cloud-based software repository using the link and to apply the downloaded firmware file to the network-connected device.

In one or more embodiments, the characteristics of the discovered network-connected device include type of the network-connected device and a firmware version of the network-connected device.

In one or more embodiments, the cloud-based software repository incorporates a catalog of network-connected devices and the corresponding firmware for supported network-connected device model types.

In accordance with yet another aspect of the inventive concepts described herein, there is provided a computer-implemented method for assisted software download, the computer-implemented method performed in connection with a computerized system incorporating: a network-connected device disposed on a local area network; a cloud-based software repository and an appliance device incorporating a processing unit and a memory, the appliance device being disposed on the local area network and communicatively coupled to the network-connected device. The computer-implemented method involves: discovering, by the appliance device, the network-connected device and determining characteristics of the discovered network-connected device; determining, by the appliance device, characteristics of a client system accessible by a user; transmitting, by the appliance device, the characteristics of the discovered network-connected device and the characteristics of the client system accessible by the user to the cloud-based software repository; receiving, by the cloud-based software repository, the characteristics of the discovered network-connected device and the characteristics of the client system accessible by the user from the appliance device; locating, in the cloud-based software repository, a suitable software based on the received two characteristics; and enabling downloading of the located suitable software to the client system accessible by a user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates an exemplary embodiment of a system for assisted driver, firmware and software download and installation.

FIG. 2 illustrates an exemplary operating sequence of the system for assisted driver, firmware and software download and installation.

FIG. 3 provides a block diagram illustrating various components of an embodiment of the appliance device described herein.

FIGS. 4, 5(a) and 5(b) illustrate exemplary embodiments of the various screens of the generated web-based graphical user interface.

FIG. 6 illustrates an exemplary embodiment of a computerized system that could be used as the user's network connected computer or the appliance device in connection with the system for assisted driver, firmware and software download and installation.

FIG. 7 illustrates an exemplary embodiment of a computerized server system, which could be used, for example, as the cloud-based software repository of the system for assisted driver, firmware and software download and installation.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

To address the above and other problems associated with the conventional technology, one or more embodiments described herein implement a network appliance that is able to proactively detect a user's operating system for a particular network enabled device and present the correct driver, firmware or other appropriate software to install on an end user's computing device with a minimum of steps. In one embodiment, the described system creates such an easy installer workflow for end users that they are not aware they are installing “drivers” but instead, installing their “printer”.

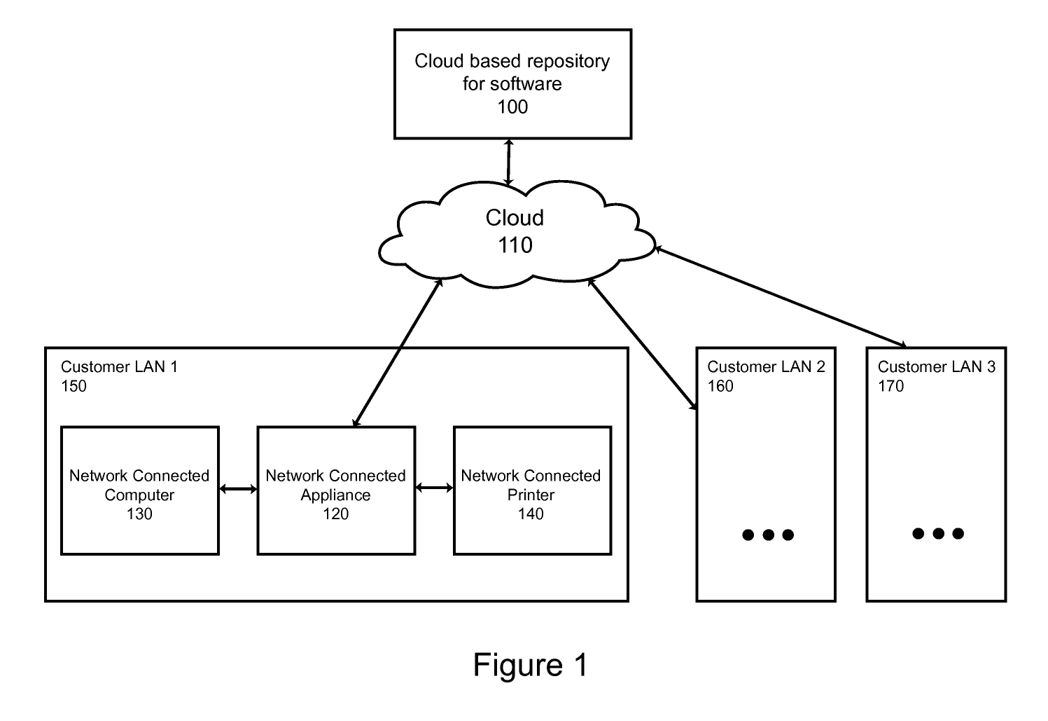

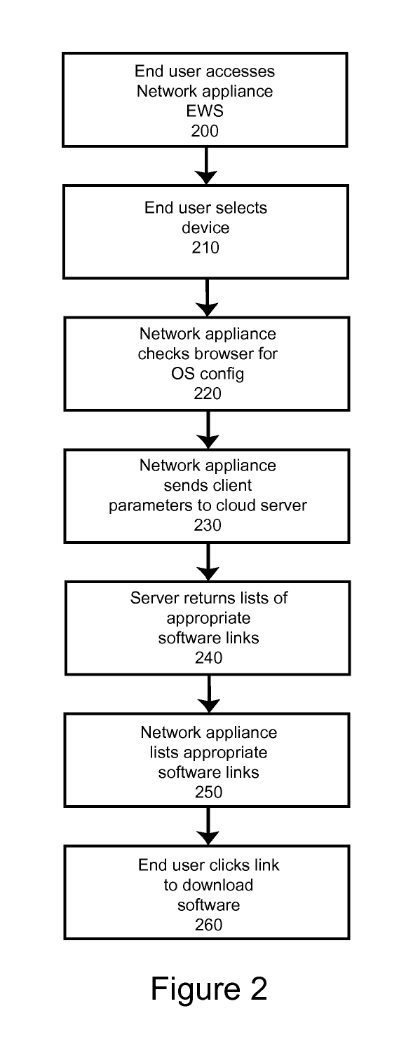

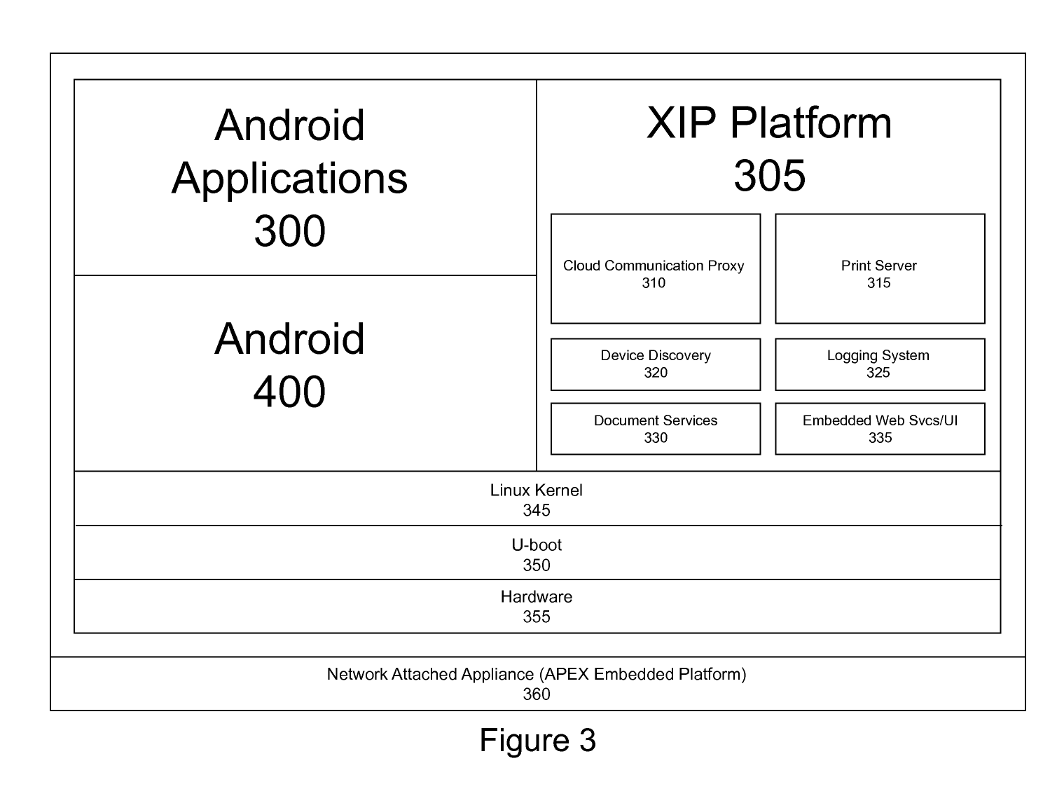

FIG. 1 illustrates an exemplary embodiment of a system for assisted driver, firmware and software download and installation. The exemplary embodiment of the system shown in FIG. 1 incorporates an appliance device 120 that resides on the end user's local area network (LAN 1) 150. The appliance device 120 may be connected to the aforesaid local area network 150 either through a WIFI connection using a suitable WIFI interface, or through a wired network connection using a network cable. In one or more embodiments, the appliance device 120 incorporates and executes client software, which is configured to connect to a cloud-based software repository 100 located on a cloud 110. In one or more embodiments, the aforesaid client software is configured to scan the local area network 150 and detect network-connected printer devices 140. An exemplary operating sequence of the system for assisted driver, firmware and software download and installation is shown in FIG. 2. FIG. 3, on the other hand, provides a block diagram illustrating various components of an embodiment of the appliance device 120 described herein.

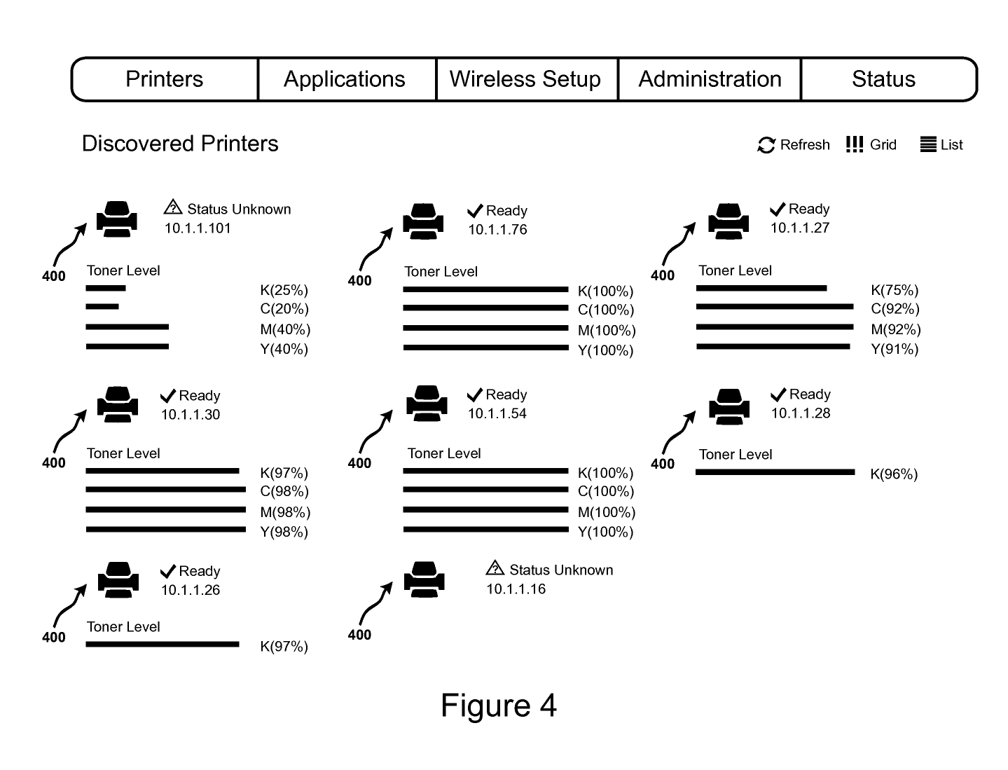

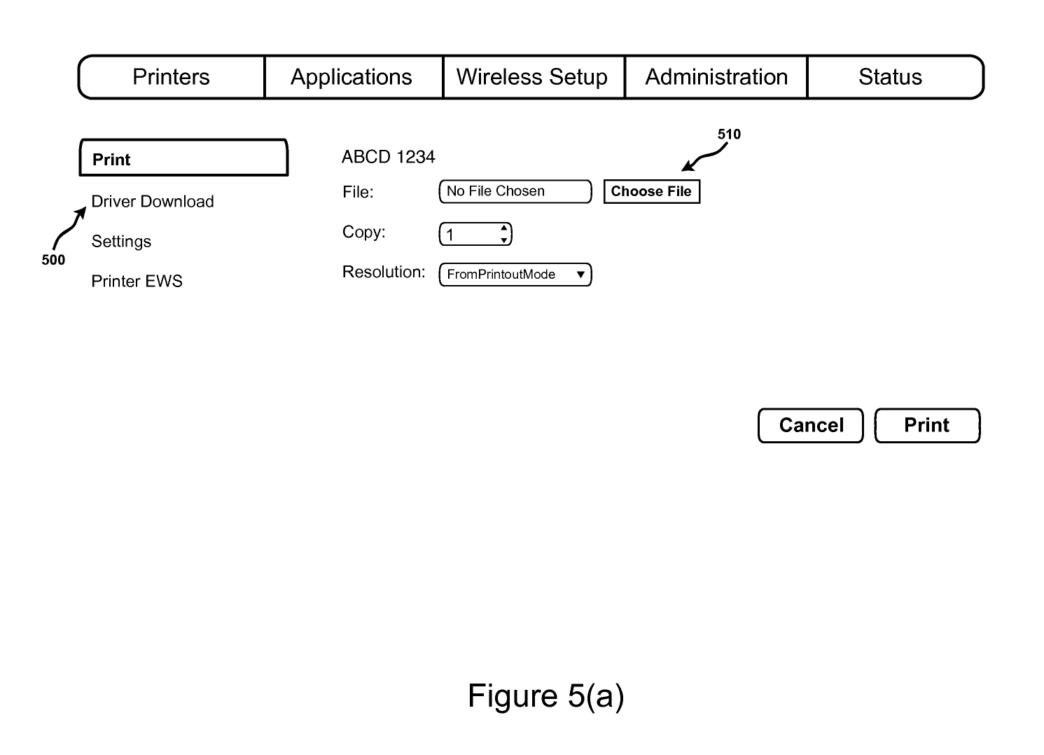

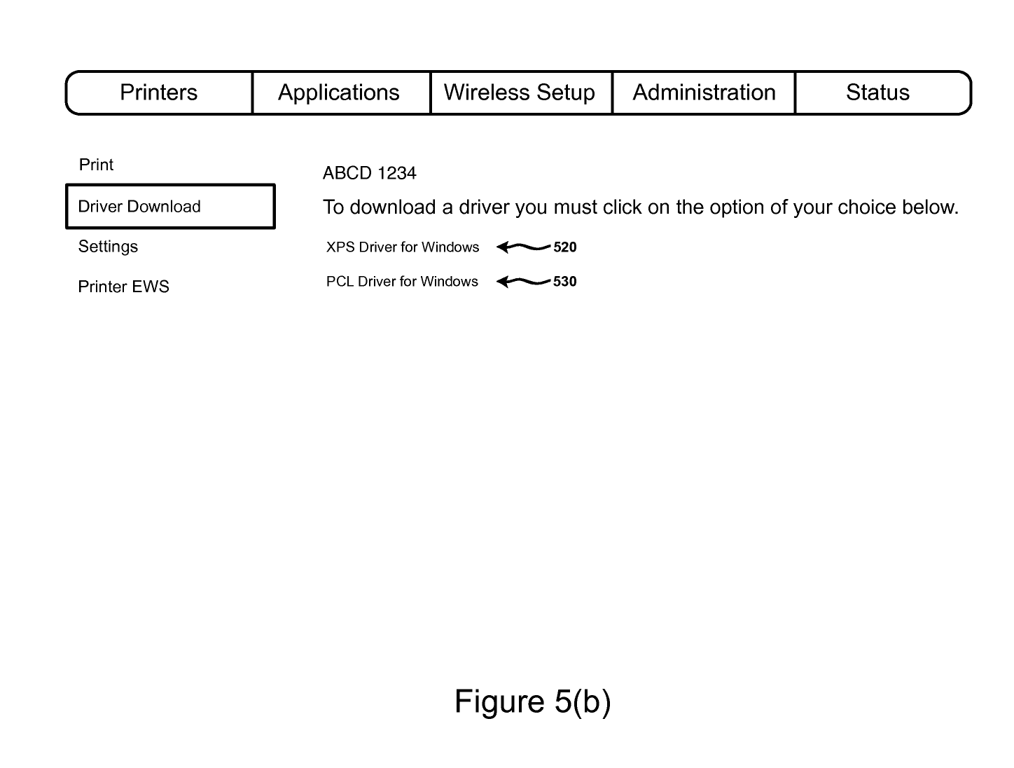

In one or more embodiments, upon the discovery of one or more network printer devices 140, the appliance device 120 creates a list of such devices 140 on the local area network 150. In one or more embodiments, the appliance device 120 incorporates an embedded web server 335 (FIG. 3), which, upon end user access request 200 (FIG. 2), creates a web-based graphical user interface on user's web browser. Exemplary embodiments of the generated web-based graphical user interface are illustrated in FIGS. 4, 5(a) and 5(b). In one or more embodiments, the user accesses the appliance device 120 via the local area network 150 using user's network connected computer 130, which executes the aforesaid web browser (not shown).

In one or more embodiments, the aforesaid web-based graphical user interface contains a network printer devices list portion illustrated in FIG. 4, which displays to the end user a list of all network printer devices 140 detected on the local area network 150. As can be seen from FIG. 4, the network printer devices 140 are represented in the list by icons 400. Certain information about each network printer device, including, for example, the current status of the device, the internet protocol (IP) address associated with the device and the toner level for each available toner color is provided next to the respective device icon 400. Using the displayed printer device list shown in FIG. 4, the end user can readily identify the detected printer devices 140. In one or more embodiments, the aforesaid network printer devices list may also include information on the network printer device model, specific device options and network printer administrator assigned name to help the end user select the correct network printer device.

In one or more embodiments, the user is enabled to select a network printer device from the aforesaid list, which selection is transmitted to the appliance device 120, see step 210 in FIG. 2. Upon the aforesaid selection of the printer device by the user, the web-based graphical user interface displays the screen substantially as shown in FIG. 5(a), which gives the user the option 500 to download the appropriate software driver for the printer device. It also provides the user with the ability to choose a file for printing, see a file input field 510 in FIG. 5(a).

The appliance device 120 is additionally configured to receive, from the user's network connected computer 130, user's browser agent information, which includes an operating system name and version of the user's network connected computer 130, see step 220 in FIG. 2. The appliance device 120 is further configured, based on the end-user-selected network printer device and the aforesaid end user's operating system name and version, to query the cloud-based software repository 100 located on the cloud 110 for a software driver or other software module appropriate for the end-user-selected network printer device 140 and the user's operating system running on the user's network connected computer 130. To this end, at step 230 in FIG. 2, the appliance device 120 sends the information on the operating system running on the user's network connected computer 130 to the cloud-based software repository 100.

In one or more embodiments, to facilitate the identification of the correct driver software, the cloud-based software repository 100 may incorporate a catalog of network printer devices and the corresponding software drivers for supported device model types. The cloud-based software repository 100 is configured, based on the operating system name and version and network printer device model information supplied by the appliance device 120, to select the correct software driver file from the aforesaid catalog and to return to the appliance device 120 a link or a list of links (such as a uniform resource locator or URL) pointing to the selected correct software driver file(s), see step 240 in FIG. 2.

In one or more embodiments, in the event the specific network printer device driver does not exist, there may be a less featured, but still functional, generic driver available in the cloud-based software repository 100 and the cloud-based software repository 100 is configured to identify that generic substitute driver and to return a link (URL) to the corresponding driver file to the appliance device 120.

In an alternative embodiment, the driver file itself may be downloaded and cached in the local storage of the appliance device 120. A link is created to this cached file within the client software executing on the appliance device 120 and provided to the user's network connected computer 130. As would be appreciated by persons of ordinary skill in the art, this embodiment has the merit of avoiding the need for additional downloads from the cloud-based software repository 100, when future end users need to install the same driver file. In this embodiment, the version of the software driver file is maintained and checked against the catalog of the cloud-based software repository 100 so that the end users are assured of getting the latest driver file.

In one or more embodiments, the link(s) to one or more software driver file(s) is displayed to the end user using the aforesaid web-based graphical user interface shown on user's web browser, which is generated by the web server executing on the appliance device 120, see step 250 in FIG. 2. An exemplary embodiment of a corresponding graphical user interface screen is shown in FIG. 5(b), which displays two driver file download links 520 and 530, which correspond to two different driver versions. The end user is enabled to click on the displayed link(s) and download the desired driver file to the local storage of the user's network connected computer 130 and to use the downloaded file to install the network connected printer device, see step 260 in FIG. 2.

As shown in FIG. 3, the appliance device 120 is deployed on a hardware platform 355, which may be a standard commercially available computerized system, described below. The embodiment of the network connected appliance 120 may further incorporate a U-boot system 350 (Universal Bootloader), which is a boot loader used by the network connected appliance 120 to boot the device's operating system kernel, such as the Linux Kernel 345. The Linux Kernel 345 implements basic system services and manages various hardware components of the aforesaid embodiment of the appliance device 120. The software application stack of the aforesaid embodiment of the appliance device 120 includes XIP platform 305, which includes various embedded applications, including the aforesaid embedded print server 315, logging system 325, an embedded web server 335, cloud communication proxy 310 for communicating with the cloud-based software repository 100, a device discovery module 320 for identifying various devices, such as print devices 140, on the local area network 150 and embedded document services 330 enabling the end user to initiate the printing of the documents. Additionally provided may be Android operating environment 340 well known to persons of ordinary skill in the art as well as custom Android applications 300.

More generally, the above-described mechanism may be used in connection with any network device that the appliance device 120 can detect on the local area network 150 and communicate with and requires software installed on an end user's network connected computer 130 to interact with that network device. Thus, the described invention is not limited to only network connected printer devices and can be utilized in connection with other types of devices as well. As would be appreciated by persons of ordinary skill in the art, the same cloud-based software repository 100 may substantially similarly serve other local area networks, such as networks 160 and 170 shown in FIG. 1.

In accordance with another aspect of the embodiments described herein, the system shown in FIG. 1 is configured to proactively detect network printer devices 140 connected to end user's local area network 150 and to automatically determine the version of firmware currently installed on each connected network printer device. In one or more embodiments, the system of FIG. 1 is configured to automatically download and apply firmware to one or more network printer devices 140 connected to end user's local area network 150. In an alternative embodiment, the system of FIG. 1 may prompt an administrator user to apply the firmware to more network printer devices 140 when convenient.

In one or more embodiments, the appliance device 120 is configured to scan the local area network 150 and detect network connected printer devices 140. Upon the discovery of the network printer devices 140, the appliance device 120 creates a list of network printer devices 140 and the associated firmware information (e.g. name, version) installed on those network printer devices 140. In one or more embodiments, the client software executing on the appliance device 120 connects to the cloud-based software repository 100 and transmits to it the aforesaid list of devices and the corresponding firmware version information.

In one or more embodiments, the cloud-based software repository 100 incorporates a catalog of network printer devices and the associated firmware for supported network printer devices model types. If a newer version of the firmware than the one currently installed on a network printer device is detected in the cloud-based software repository 100, the system shown in FIG. 1 can take several actions, based on end user preferences.

In one embodiment, the system may signal the client application executing on the appliance device 120 to download the firmware from the cloud-based software repository 100 and update the firmware in the network printer device(s) automatically. In another embodiment, the system may send an electronic alert (email, text, etc.) to the administrator user with a list of network printer devices that need to be updated and with links (URLs) to the updated firmware files that the administrator user would run and install manually. Alternatively, the client application executing on the appliance device 120 could download the firmware from the cloud-based software repository 100 locally and stage it so that the link (URL) sent to the end user administrator would be to the web server of local appliance device 120, reducing the download time.

As would be appreciated by persons of ordinary skill in the art, the use of the described embodiments ensures a proactive identification of the correct and latest firmware for the network enabled device(s) being monitored. Thus, the described system streamlines the process of keeping that network-enabled device up-to-date. As would be appreciated by persons of ordinary skill in the art, the described system is not limited to only network connected printer devices and can be utilized in connection with other types of devices as well.

### Computing Platforms

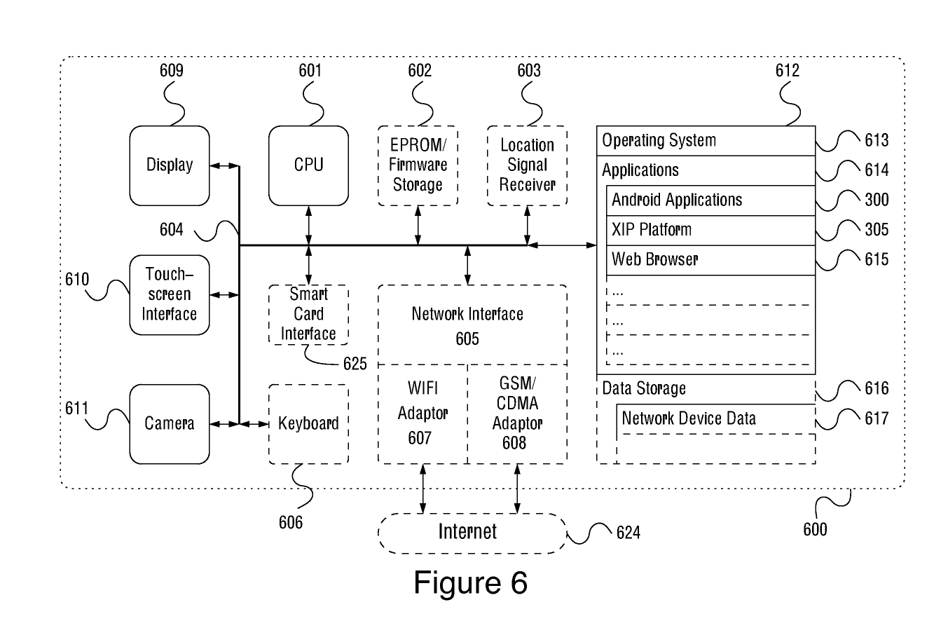

FIG. 6 illustrates an exemplary embodiment of a computerized system 600 that could be used as the user's network connected computer 130 or the appliance device 120 in connection with the system for assisted driver, firmware and software download and installation shown in FIG. 1. In one or more embodiments, the computerized system 600 may be implemented within a form factor of a mobile computing device, such as a smartphone, a personal digital assistant (PDA), a tablet computer, or a smart watch. In an alternative embodiment, the computerized system 600 may be implemented based on a laptop, a notebook or a desktop computer. Yet in an alternative embodiment, the computerized system 600 may be an embedded system, incorporated into an electronic device with certain specialized functions, such as an electronic book (or e-book) reader, scanner or copier. Yet in an alternative embodiment, the computerized system 600 may be implemented as a part of an augmented reality head-mounted display (HMD) systems, such as Google glass, also well known to persons of ordinary skill in the art.

The computerized system 600 may include a data bus 604 or other interconnect or communication mechanism for communicating information across and among various hardware components of the computerized system 600, and a central processing unit (CPU or simply processor) 601 coupled with the data bus 604 for processing information and performing other computational and control tasks. Computerized system 600 also includes a memory 612, such as a random access memory (RAM) or other dynamic storage device, coupled to the data bus 604 for storing various information as well as instructions to be executed by the processor 601. The memory 612 may also include persistent storage devices, such as a magnetic disk, optical disk, solid-state flash memory device or other non-volatile solid-state storage devices.

In one or more embodiments, the memory 612 may also be used for storing temporary variables or other intermediate information during execution of instructions by the processor 601. Optionally, computerized system 600 may further include a read only memory (ROM or EPROM) 602 or other static storage device coupled to the data bus 604 for storing static information and instructions for the processor 601, such as firmware necessary for the operation of the computerized system 600, basic input-output system (BIOS), as well as various configuration parameters of the computerized system 600.

In one or more embodiments, the computerized system 600 may incorporate a display device 609, which may be also coupled to the data bus 604, for displaying various information to a user of the computerized system 600, such as the graphical user interface screens shown in FIGS. 4, 5(a) and 5(b). In an alternative embodiment, the display device 609 may be associated with a graphics controller and/or graphics processor (not shown). The display device 609 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 609 may be incorporated into the same general enclosure with the remaining components of the computerized system 600. In an alternative embodiment, the display device 609 may be positioned outside of such enclosure.

In one or more embodiments, the computerized system 600 may further incorporate a smart card interface 625 connected to the data bus 604 and configured to read information encoded on a smart card inserted by the end user. This encoded information may contain end user's credentials.

In one or more embodiments, the computerized system 600 may incorporate one or more input devices, such as a touchscreen interface 610 for receiving tactile commands, a camera 611 for acquiring still images and video of various objects, as well as a keyboard 606, which all may be coupled to the aforesaid data bus 604 for communicating information, including, without limitation, images and video, as well as user command selections to the processor 601. In an alternative embodiment, input devices may include a system for tracking eye movements of the user (not shown), which may be used to indicate to the computerized system 600 the command selection by the user. In yet alternative embodiment, the computerized system 600 may incorporate a voice command interface for receiving voice control commands from the user.

In one or more embodiments, the computerized system 600 may additionally include a location signal receiver 603 configured to perform scan for GPS signal(s), determine the geographical location of the computerized system 600 based on the detected GPS signal(s) and communicate the determined geographical location information to the processor 601 via the data bus 604.

In one or more embodiments, the computerized system 600 may additionally include a communication interface, such as a network interface 605 coupled to the data bus 604. The network interface 605 may be configured to establish a connection between the computerized system 600 and the Internet 624 using at least one of WIFI interface 607 and the cellular network (GSM or CDMA) adaptor 608. The network interface 605 may be configured to provide a two-way data communication between the computerized system 600 and the Internet 624. The WIFI interface 607 may operate in compliance with 802.11a, 802.11b, 802.11g and/or 802.11n protocols as well as Bluetooth protocol well known to persons of ordinary skill in the art. In an exemplary implementation, the WIFI interface 607 and the cellular network (GSM or CDMA) adaptor 608 send and receive electrical or electromagnetic signals that carry digital data streams representing various types of information.

In one or more embodiments, the Internet 624 typically provides data communication through one or more sub-networks to other network resources. Thus, the computerized system 600 is capable of accessing a variety of network resources located anywhere on the Internet 624, such as web servers, other content servers as well as other network data storage resources. In one or more embodiments, the computerized system 600 is configured to send and receive messages, media and other data, including application program code, through a variety of network(s) including Internet 624 by means of the network interface 605. In the Internet example, when the computerized system 600 acts as a network client, it may request code or data for an application program executing on the computerized system 600. Similarly, it may act as a network server and send various data or computer code to other network resources.

In one or more embodiments, the computerized system 600 uses the network interface 605 to send request(s), via the Internet 624, such as HTTP requests, to the various servers and receive various information, including, without limitation, the aforesaid information displayed to the user using the user interface screens shown in FIGS. 4, 5(a) and 5(b).

In one or more embodiments, the functionality described herein is implemented by computerized system 600 in response to processor 601 executing one or more sequences of one or more instructions contained in the memory 612. Such instructions may be read into the memory 612 from another computer-readable medium. Execution of the sequences of instructions contained in the memory 612 causes the processor 601 to perform the various process steps described herein. In alternative embodiments, hard-wired circuitry may be used in place of or in combination with software instructions to implement the embodiments of the invention. Thus, embodiments of the invention are not limited to any specific combination of hardware circuitry and/or software.

The term “computer-readable medium” as used herein refers to any medium that participates in providing instructions to processor 601 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 901 for execution. For example, the instructions may initially be carried on a magnetic disk from a remote computer. Alternatively, a remote computer can load the instructions into its dynamic memory and send the instructions over the Internet 624. Specifically, the computer instructions may be downloaded into the memory 612 of the computerized system 600 from the foresaid remote computer via the Internet 624 using a variety of network data communication protocols well known in the art.

In one or more embodiments, the memory 612 of the computerized system 600 may store any of the following software programs, applications or modules:

1. Operating system (OS) 613, which may be a mobile operating system for implementing basic system services and managing various hardware components of the computerized system 600. Exemplary embodiments of the operating system 613 are well known to persons of skill in the art, and may include Mac OS, iOS, Android, Windows, Windows Mobile, Linux, Unix or any other now known or later developed operating system(s).

2. Applications 614 may include, for example, a set of software applications executed by the processor 601 of the computerized system 600, which cause the computerized system 600 to perform certain predetermined functions, such as generate the graphical user interface screens shown in FIGS. 4, 5(a) and 5(b). In one or more embodiments, the applications 614 may include, for example, the Android applications 300, the XIP platform 305 and/or web browser application 615.

3. Data storage 616 may be used, for example, for storing information 617 about network printer devices 140 on the LAN 150 as well as other suitable statistical information.

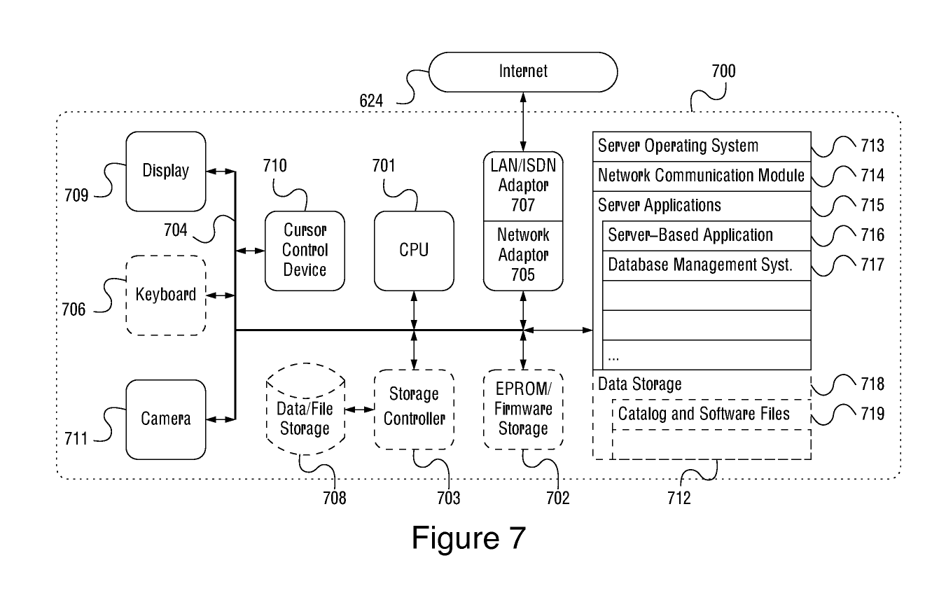

FIG. 7 illustrates an exemplary embodiment of a computerized server system 700 which could be used, for example, as the cloud-based software repository 100 of the system for assisted driver, firmware and software download and installation shown in FIG. 1.

In one or more embodiments, the computerized server system 700 may incorporate a data bus 704, which may be substantially similar and may perform substantially similar functions as the data bus 704 of the computerized system 600 illustrated in FIG. 6. In various embodiments, the data bus 704 may use the same or different interconnect and/or communication protocol as the data bus 604. The one or more processors (CPUs) 701, the network adaptor 705, the EPROM/Firmware storage 702, the display device 709 and the keyboard 706 of the computerized server system 700 may be likewise substantially similar to the respective processor 601, the network interface 605, the EPROM/Firmware storage 602, the display device 609 and the keyboard 606 of the computerized system 600, except that the former components are deployed in a server platform configuration. In various implementations, the one or more processor 701 may have substantially increased processing power as compared with the processor 601.

In addition to the input device 706 (keyboard), the computerized server system 700 may additionally include a cursor control device 710, such as a mouse, a trackball, or cursor direction keys for communicating direction information and command selections to processor 701 and for controlling cursor movement on the display device 709. This input device typically has two degrees of freedom in two axes, a first axis (e.g., x) and a second axis (e.g., y), that allows the device to specify positions in a plane.

The LAN/ISDN adaptor 707 of the computerized server system 700 may be implemented, for example, using an integrated services digital network (ISDN) card or a modem to provide a data communication connection to a corresponding type of telephone line, which is interfaced with the Internet 624 using Internet service provider's hardware (not shown). As another example, the LAN/ISDN adaptor 707 may be a local area network interface card (LAN NIC) to provide a data communication connection to a compatible LAN and the Internet 624. To store various data files, such as firmware and/or driver files, the computerized server system 700 may be provided with storage 708, connected to the data bus 704 by means of a storage controller 703. The camera 711 may be used to acquire images and/or video of various objects.

In one or more embodiments, the memory 712 of the computerized server system 700 may store any of the following software programs, applications, modules and/or data:

1. A server operating system (OS) 713, which may be an operating system for implementing basic system services and managing various hardware components of the computerized server system 700. Exemplary embodiments of the server operating system 713 are all well known to persons of skill in the art, and may include Windows Server, Mac OS, Unix, AIX, FreeBSD, Linux, as well as any now known or later developed operating systems.

2. A network communication module 714 may incorporate, for example, one or more network protocol stacks which are used to establish a networking connection between the computerized server system 700 and the various network entities of the Internet 624, such as the computerized system 600, using the network adaptor 705 working in conjunction with the LAN/ISDN adaptor 707.

3. Server applications 715 may include, for example, a set of software applications executed by one or more processors 701 of the computerized server system 700, which cause the computerized server system 700 to perform certain predetermined functions or tasks. In one or more embodiments, the server applications 715 may include the server-based application 716, for performing functions described in detail above. Additionally provided may be a database management system 717 for storing and managing access to various information, as described in detail above, such as the catalog as well as the driver, firmware and other software files.

4. Data storage 718 may be used, for example, for storing the aforesaid information, including the catalog as well as the driver, firmware and other software files 719, which may be stored in a form of one or more database tables and/or database objects, such as relational database tables and objects.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, Android as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in various systems and methods for assisted driver, firmware and software download. It is intended that the specification and examples be considered as exemplary only, with a true scope and spirit of the invention being indicated by the following claims.

What is claimed is:

1. A computerized system for assisted software download, the system comprising:
a. a network-connected device disposed on a local area network;
b. a cloud-based software repository; and
c. an appliance device disposed on the local area network and communicatively coupled to the network-connected device, the appliance device comprising a processing unit and a memory and configured to:
i. discover the network-connected device and determine characteristics of the discovered network-connected device;
ii. determine characteristics of a client system accessible by a user; and
iii. transmit the characteristics of the discovered network-connected device and the characteristics of the client system accessible by the user to the cloud-based software repository,
wherein the cloud-based software repository is configured to receive the characteristics of the discovered network-connected device and the characteristics of the client system accessible by the user from the appliance device, to locate a suitable software based on the received two characteristics and to enable downloading of the located suitable software to the client system accessible by a user.

2. The computerized system of claim 1, wherein the network-connected device is a network-connected printer.

3. The computerized system of claim 1, wherein enabling downloading of the located suitable software to the client system accessible by a user comprises transmitting a link pointing to a file for the software from the cloud-based software repository to the appliance device.

4. The computerized system of claim 1, wherein enabling downloading of the located suitable software to the client system accessible by a user comprises displaying a link pointing to a file for the software located in the cloud-based software repository on the client system accessible by a user.

5. The computerized system of claim 4, wherein the appliance device comprises a web server configured to generate a web-based user interface comprising the link pointing to a file for the software located in the cloud-based software repository.

6. The computerized system of claim 5, wherein the web-based user interfaces comprises a list of the discovered network-connected devices.

7. The computerized system of claim 6, wherein the link pointing to a file for the software located in the cloud-based software repository is displayed upon selection of by a user of a corresponding network-connected device from the list of the discovered network-connected devices.

8. The computerized system of claim 1, wherein enabling downloading of the located suitable software to the client system accessible by a user comprises downloading a file for the software from the cloud-based software repository to the appliance device, storing the software file on the appliance device and displaying a link pointing to the software file stored on the appliance device on the client system accessible by a user.

9. The computerized system of claim 1, wherein the software is a driver for the network-connected device.

10. The computerized system of claim 1, wherein the characteristics of a client system comprise operating system name and version.

11. The computerized system of claim 1, wherein the characteristics of the discovered network-connected device comprise the type of the network-connected device.

12. The computerized system of claim 1, wherein the cloud-based software repository comprises a catalog of network-connected devices and the corresponding software drivers for supported network-connected device model types.

13. A computerized system for assisted firmware download and installation, the system comprising:
a. a network-connected device disposed on a local area network;
b. a cloud-based software repository; and
c. an appliance device disposed on the local area network and communicatively coupled to the network-connected device, the appliance device comprising a processing unit and a memory and configured to:
i. discover the network-connected device and determine characteristics of the discovered network-connected device; and
ii. transmit the characteristics of the discovered network-connected device to the cloud-based software repository,
wherein the cloud-based software repository is configured to receive the characteristics of the discovered network-connected device to locate a suitable firmware based on the received characteristics and to enable downloading of the located suitable firmware for updating firmware of the network-connected device.

14. The computerized system of claim 13, wherein the network-connected device is a network-connected printer.

15. The computerized system of claim 13, wherein enabling downloading of the located suitable firmware comprises transmitting a link pointing to a file for the firmware from the cloud-based software repository to the appliance device.

16. The computerized system of claim 15, wherein the appliance device is further configured to automatically download the firmware file from the cloud-based software repository using the link and to apply the downloaded firmware file to the network-connected device.

17. The computerized system of claim 15, wherein the appliance device is further configured to prompt a user to download the firmware file from the cloud-based software repository using the link and to apply the downloaded firmware file to the network-connected device.

18. The computerized system of claim 13, wherein the characteristics of the discovered network-connected device comprise type of the network-connected device and a firmware version of the network-connected device.

19. The computerized system of claim 13, wherein the cloud-based software repository comprises a catalog of network-connected devices and the corresponding firmware for supported network-connected device model types.

20. A computer-implemented method for assisted software download, the computer-implemented method performed in connection with a computerized system comprising: a network-connected device disposed on a local area network; a cloud-based software repository and an appliance device comprising a processing unit and a memory, the appliance device being disposed on the local area network and communicatively coupled to the network-connected device, the computer-implemented method comprising:
i. discovering, by the appliance device, the network-connected device and determining characteristics of the discovered network-connected device;
ii. determining, by the appliance device, characteristics of a client system accessible by a user;
iii. transmitting, by the appliance device, the characteristics of the discovered network-connected device and the characteristics of the client system accessible by the user to the cloud-based software repository;
iv. receiving, by the cloud-based software repository, the characteristics of the discovered network-connected device and the characteristics of the client system accessible by the user from the appliance device;
v. locating, in the cloud-based software repository, a suitable software based on the received two characteristics; and
vi. enabling downloading of the located suitable software to the client system accessible by a user.
